(19) United States
(12) Patent Application Publication
(10) Pub. No.: US 2005/0066542 A1
(43) Pub. Date: Mar. 31, 2005

(54) Fabric treatment device

(75) Inventors: Jeannine Desmond Griffiths, Kinnelon, NJ (US); Nancy Ann Falk, Livingston, NJ (US); Laurie Mallon, Bergenfield, NJ (US); Daniel Joseph Fox, Tenafly, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/671,287

(22) Filed: Sep. 25, 2003

(51) Int. Cl. F26B 11/02

(52) U.S. Cl. 34/597

(57) ABSTRACT

The invention provides a device for treating fabrics in a tumble dryer comprising a patch having a front side and a back side, wherein the back side has a means for attaching the patch to an interior surface of a tumble dryer, wherein the front side is a carrier material that is impregnated with a fabric treatment composition and wherein the patch is attached to the interior surface of a tumble dryer door or back wall, whereby a portion of the fabric treatment composition is transferred onto fabrics in the tumble dryer as a result of contact between the patch and fabrics during a tumble drying cycle.

### BACKGROUND OF THE INVENTION

The present invention relates to a device for treating fabrics inside a tumble dryer, particularly a device that attaches to the interior surface of the door of the tumble dryer and is capable of multiple uses.

In the treatment of fabrics in a tumble dryer it is known to add one or more conditioning agents. For instance, for imparting a softening benefit to fabrics it is known from CA 1,005,204 to co-mingle fabrics in a tumble dryer with a flexible substrate carrying a normally solid fabric conditioning agent. The co-mingling of the fabrics with impregnated substrates requires the separation of the substrate from the fabrics after the completion of the tumble dryer treatment. Especially in using flexible substrates, this separation is often time-consuming in that the substrates cannot readily be located. Other disadvantages of such products include uneven product distribution following entanglement of the substrate with fabrics which can lead to greasy marks on fabrics (staining) and the tendency of such substrates to become positioned over the tumble dryer vent, thus giving virtually no benefit to the fabrics during a tumble drying cycle. Furthermore, these products are designed for single use only and therefore need to be replaced after every cycle.

For overcoming these problems it has been suggested, for instance in GB 2,066,309 and U.S. Pat. No. 3,634,947, to use conditioner dispensing articles, comprising means for attachment of the substrate to the tumble dryer drum wall. Other proposals, such as for instance disclosed in GB 1,399,728 involve the use of separate means for attaching the conditioning article to the tumble dryer drum wall.

EP-B-361593 concerns an alternative approach in which a fabric conditioning article comprises a combination of a substrate and a fabric conditioning composition, the substrate being a porous material with a specified void volume and cell count. The article of EP-B-361593 is designed to adhere to the tumble dryer drum wall or fins thereupon.

Thus, known methods of treating fabrics in a tumble dryer include co-mingling a flexible substrate with the fabrics or providing a fabric conditioning article on the tumble dryer drum wall. However, applicants have found that fabrics in a tumble dryer typically migrate towards the front of the dryer drum and continuously contact the interior surface of the tumble dryer door.

It is an object of the present invention to provide an improved device suitable for treatment fabrics in a tumble dryer. It is also an object to provide a device capable of efficient and accurate dosing of the fabric treatment composition.

### SUMMARY OF THE INVENTION

Application of a fabric treatment device to the dryer door can result in less staining of clothes by the conditioner than if the device is applied to the dryer drum or fins thereupon, as clothes will rest upon the drum and fins upon completion of the drying cycle. This is especially important in a multiple-use products where the fabric treatment device will contain more fabric treatment composition than a single use device.

According to the present invention, there is provided a device for treating fabrics in a tumble dryer comprising a patch having a front side and a back side, wherein the back side has a means for attaching the patch to an interior surface of a tumble dryer door and the front side contains a carrier material that is impregnated with a fabric treatment composition, and wherein the patch is attached to the interior surface of a tumble dryer door whereby a portion of the fabric treatment composition is transferred onto fabrics in the tumble dryer as a result of contact between the patch and fabrics during a tumble drying cycle.

In a second aspect of the invention, there is provided a device for treating fabrics in a tumble dryer comprising a patch having a front portion, a middle portion, and a back portion, wherein the back portion has a means for attaching the patch to an interior surface of a tumble dryer door, the middle portion contains a carrier that is impregnated with a fabric treatment composition, and the front portion contains a flow control member, and wherein the patch is attached to the interior surface of a tumble dryer door whereby a portion of the fabric treatment composition is transferred onto fabrics in the tumble dryer as a result of contact between the patch and fabrics during a tumble drying cycle.

As used herein, the term “flow control member” is intended to refer to any material that provides impedance/control of the flow of fabric treatment composition passing from the carrier to the outermost surface of the device where it is exposed to directly contact fabrics during operation of the tumble drying cycle.

In a third aspect of the invention, there is provided a device for treating fabrics in a tumble dryer comprising a patch having a front portion, a middle portion, and a back portion, wherein the back portion has a means for attaching the patch to an interior surface of a tumble dryer door, the middle portion contains a carrier that is impregnated with a fabric treatment composition, and the front portion contains a support member, and wherein the patch is attached to the interior surface of a tumble dryer door whereby a portion of the fabric treatment composition is transferred onto fabrics in the tumble dryer as a result of contact between the patch and fabrics during a tumble drying cycle. The support member provides improved resistance to wear, less adhesion of lint and/or protection of the fabric treatment composition carrier and/or flow control member prior to first use.

Various aspects of these embodiments may be combined and used interchangeably. Additionally, a single part of the device may have multiple functions. For example, the flow control member may also act as a support member.

In each of these embodiments, the device for treating fabrics is attached to the interior surface of the tumble dryer door. With this configuration, the applicants have found that the outermost surface can more easily contact the fabrics in the dryer, thereby transferring a portion of the fabric treatment composition onto the fabrics in the tumble dryer during a tumble drying cycle.

### BRIEF DESCRIPTION OF THE DRAWINGS

FIG. 1 is a cross sectional view of a device in accordance with the present invention.

FIG. 2 is a cross sectional view of another embodiment of a device in accordance with the present invention.

FIG. 3 is a view of a device in accordance with the present invention placed on the interior surface of a tumble dryer door.

### DETAILED DESCRIPTION OF THE INVENTION

Referring now particularly to the drawings, device 10 comprises a patch 12 having a front side 14 and a back side 16. The terms “side” and “portion” are used interchangeably herein. A middle portion 18 may also be present when a separate member is used as a flow rate member or a support member. The back side 16 has means for attaching the device 10 to the interior surface 50 of a tumble dryer door. The front side 14 has impregnated in it a fabric treatment composition. A peelable pressure sensitive seal 20 and 22 may be applied to the front and back sides. The seals 20 and 22 are removed once the device is attached to the tumble dryer for use. For instance, the seal 20 on the back side will expose an adhesive than is in the back side of the device thus enabling the user to apply the device to the tumble dryer door. Also, the seal 22 which is on the front surface of the device will help keep the front side fresh and limit exposure to air until the product is ready for use.

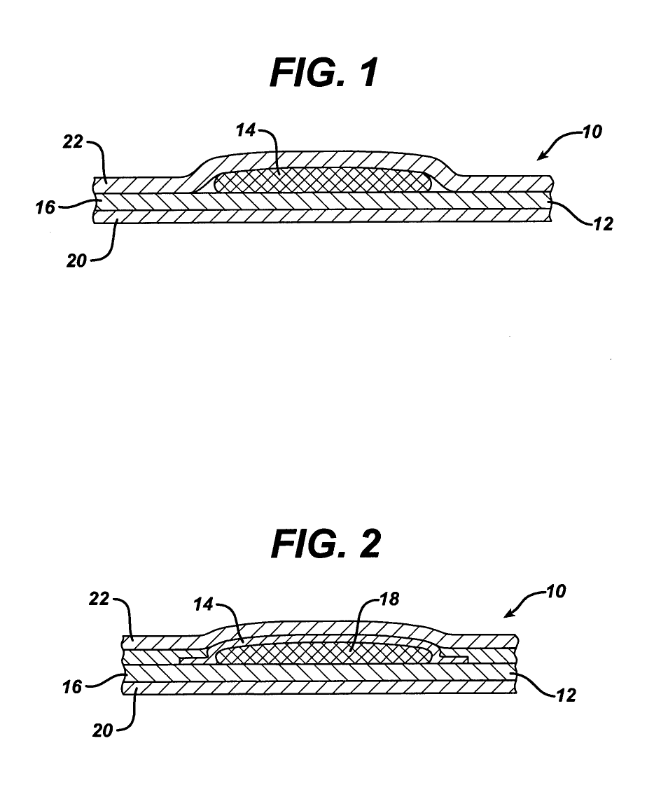

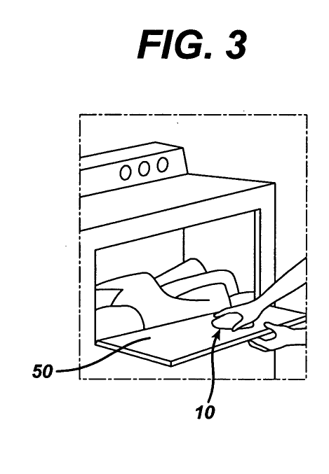

Referring to the embodiment shown in FIG. 1, the device itself has 2 portions, a back portion 16 and a front portion 14. The seals 20 and 22 are removed from the device once ready to be attached to the dryer door and ready for use. The back portion 16 has an adhesive on its surface which acts as an attachment means for the device. The front portion 14 has a fabric treatment composition impregnated in it which is transferred to the fabric being treated during a crying cycle. The portions are connected by connection means such as an adhesive.

Referring to the embodiment shown in FIG. 2, the device itself has 3 portions, a back portion 16, a front portion 14, and a middle portion 16. The seals 20 and 22 are removed from the device once ready to be attached to the dryer door and ready fir use. The back portion 16 has an adhesive on its surface which acts as an attachment means for the device. The middle portion 14 has a fabric treatment composition impregnated in it which is transferred to the fabric being treated during a crying cycle. The front portion is either a flow control member and/or a support member. The portions are connected by connection means such as an adhesive.

The front and middle portions may play a dual role and may act as any of a carrier, flow control member and/or a support member. The back portion may also act as a carrier of fabric treatment composition as well as providing the adhesive means. In fact, the device may have a single layer that is a carrier for fabric treatment composition as well as provide a substrate for the adhesive means.

The materials used for the outermost layer should be mechanically strong (i.e. mechanically wear, puncture, and or tear resistant)as the outermost layer will be subject to mechanical wear by tumbling fabrics, zippers, buttons, hooks etc. during a tumble dry cycle. In an embodiment having a middle portion and a front portion, the outermost member (i.e. front portion) may be of greater mechanical strength and/or smoothness than the middle portion. Thus, the front portion will provide mechanical protection to the middle portion and prevent the device from premature wear, puncture or tear from the tumble drying operation. In addition, the fabrics being treated will be less likely to be damaged by contact with rough surfaces.

The front and/or middle portion may comprise a carrier for a fabric treatment composition. The carrier may, for example, comprise a membrane, or a layer of e.g. semi permeable and/or absorbent materials e.g. polyester, polypropylene, polyethylene, nylon, rayon, cellulosics, polyacrylates or the like or a woven/non-woven membrane. Preferably, the material will have a balance of hydrophilic and hydrophobic properties to enable absorption and subsequent release.

The carrier shall be impregnated with a sufficient amount of fabric treatment composition to provide a predetermined amount of the composition that will mechanically transfer to the fabrics from the carrier during a tumble drying cycle. The application of compositions such as fabric treatment compositions into substrates or carrier materials is known in the art. One such techniques is discussed in U.S. Pat. No. 6,352,969 issued Mar. 5, 2002, the contents of which is incorporated by reference. The device should deliver a total of 1-100 grams, preferably, 5-50 grams, and more preferably 5-25 grams, and including all ranges subsumed therein, of the fabric treatment composition during the devices usable life. Additionally, during each use 0.1-3.0 grams, preferably 0.5-2.0 grams, and more preferably 1.0-1.5 grams, and including all ranges subsumed therein, of fabric treatment composition is applied to the load of fabrics being treated during a single drying cycle.

The transfer of fabric treatment composition to the fabrics in the tumble dryer may be effected primarily by direct contact between fabric in the tumble dryer and the device.

The device is preferably configured to present a relatively flat external profile when attached to the interior surface of a tumble dryer door. This configuration has the advantage that it prevents or at least can reduce the possibility of the device inadvertently latching onto the fabrics, which may damage the fabrics as they move through the dryer. This configuration will prevent the device from being detached from the door by contact with the fabrics. Additionally, the device is preferably flexible or at least flexible enough to conform to the shape of the interior surface of a dryer door. This will enable the device to be used on any type of dryer door regardless of the shape or configuration of the interior surface of the dryer door. For example, the device may be applied on dryer doors which have an interior surface which is concave, convex, have holes in it or any other configuration.

The carrier may be impregnated with sufficient fabric treatment composition for any number of drying cycles and for instance the carrier may hold sufficient composition for a single cycle. With this arrangement, different compositions could be used for different drying cycles allowing greater flexibility for the user.

Preferably the device can be used to treat fabrics during multiple tumble drying cycles. The carrier of the device of the invention may be capable of holding sufficient fabric treatment composition for a plurality of drying cycles of the tumble dryer. With this arrangement, the dispenser may be more convenient as the user only need replace the device after a number of cycles.

The device preferably has a means for indicating to the user when the fabric treatment composition is used up which has the advantage of enabling the user to determine when the device needs replacing. Preferably this means comprises visible indicia associated with the device. For example, the outermost surface of the device which is visible to the user may undergo an appearance change, for example changes color, once the fabric treatment composition is used up. Such indicating means may be provided as disclosed in U.S. Pat. No. 4,550,676, the contents of which is incorporated by reference. In this instance, the user would simply inspect the outermost surface of the device to see if it has changed in appearance, such as a change in color. The device may also continually change appearance as fabric treatment composition is used up such that the user is continuously informed after each use as to the approximate amount of fabric treatment composition remaining in the device. For instance, the patch may be a green color when new and red when empty. As the patch is used it may turn a shade of orange before it turns red to indicate to the user that it is low and that it will be empty soon. This enables the user to get a replacement before this one that is low runs out completely.

A further advantage of attachment of the device to the tumble dryer door is that it makes it easier to replace the device when the fabric treatment composition is used up than is the case with prior art devices attached to the tumble dryer drum wall.

Preferably, the device has attachment means for attaching the device to the interior surface of the tumble dryer door. The provision of attachment means has a number of advantages over prior art devices. It is easier for a user to affix a device to the inside of the tumble dryer door, which swings open to face the user during loading and unloading of the tumble dryer, than it is to affix a device inside the tumble dryer drum as is the case with prior art devices. Once affixed to the inside of the tumble dryer door the device of the invention is easily and clearly visible to the user during loading and unloading of the tumble dryer. Thus the user has clear view of the device to determine if it is almost empty. While it is preferable that the device is attached to the interior surface of the dryer door, it may also be attached to the back wall of the dryer. While this may not be as convenient for the user to install and observe after each use, this will still provide the benefits such as prevent staining as is encountered when a fabric treatment article is positioned on the drum of the dryer.

The present device is also easy to install compared to some other devices such as that disclosed in U.S. patent application Ser. No. 2002/0,078,589 published on Jun. 27, 2002, the contents of which is incorporated by reference. The present device may be installed without any need for orientation, unlike the device disclosed in U.S. patent application Ser. No. 2002/0,078,589.

The means for attaching the device to the inside of the tumble dryer door may comprise adhesive means, for example in the form of an adhesive material situated on the back surface of the device. The adhesive should be capable of providing suitable adhesion at elevated temperatures as is found in the chamber of a tumble dryer during the drying cycle. Alternatively, suction means may be used in the form of, for example, a suction pad. Other suitable attachment means include hooks, claws and Velcro™. It may be desirable to provide more than one different type of attachment means on the device for versatility in different tumble dryer environments. For example a suction form of attachment would be suitable for attaching the device to the glass/plastic/metal door of a conventional tumble dryer (usually with an external vent). However, many modern tumble dryers have a number of small holes in the inside of the door to allow moisture out of the tumble dryer drum to condense in a tray below or vented to the outside of the machine. In this case, a hook or claw attachment on the device may be more suitable. However, it is not always the case that condenser machines require a hook-type faster and vented machines require a sucker. Some condenser machines are configured such that a sucker works better, and vice versa. There are other ways of attaching the device to the door, e.g. by a magnet, by a bayonet clip, by glue, by extendable arms which may have a raw plug configuration. The device may include a mounting bracket/frame for attachment to the dryer door, to which the device body is then attached.

The fabric treatment composition preferably comprises one or more ingredients to impart desired benefits to the fabrics. These ingredients can include, for example, perfumes, anti-static agents, dye transfer inhibitors, whitening agents, enzymes, stain repellents, insect repellents, sunscreens, malodour reduction, stain removers, and wrinkle reducing agents.

Fabric conditioner applications preferably contain cationic and/or nonionic surfactants to provide softness, fragrance delivery, and anti-static properties. Such surfactants should be chosen so that the melting point of the composition is between 90° and 100° F. Furthermore, the flow characteristics of the composition should yield little to no independence on temperature or shear rate in its molten state. This allows for uniform and even distribution in the cycling of temperatures in a tumble dryer. Some examples of such surfactants include quaternary ammonium surfactants and alcohol ethyl/fatty acids mixtures.

In addition, according to the invention there is provided a method of treating fabrics in a tumble dryer during multiple tumble drying cycles comprising attaching a device according to the invention to the interior surface of a tumble dryer door and carrying out a tumble drying process with fabrics inside the tumble dryer.

Further provided in accordance with the invention is a tumble dryer with a device according to the invention attached therein.

1. A device for treating fabrics in a tumble dryer comprising a patch having a front side and a back side, wherein the back side has on it an adhesive for attaching the patch to an interior surface of a tumble dryer, wherein the front side is a carrier material that is impregnated with a fabric treatment composition, wherein the patch is attached to the interior surface of a tumble dryer door or back wall, whereby a portion of the fabric treatment composition is transferred onto fabrics in the tumble dryer as a result of contact between the patch and fabrics during a tumble drying cycle and wherein the fabric treatment composition is present in an amount to be used for multiple tumble drying cycles.

2. A device according to claim 1 wherein the fabric treatment composition is selected from the group consisting of perfumes, anti-static agents, dye transfer inhibitors, whitening agents, enzymes, stain repellents, insect repellents, sunscreens, malodour reduction or elimination agents, stain removers, and wrinkle reducing agents.

3. A device according to claim 1 wherein the device has an indicating means which indicates to the user when the device is either low or out of fabric treatment composition.

4. (Cancelled)

5. (Cancelled)

6. A device according to claim 1 wherein the device is flexible.

7. A device for treating fabrics in a tumble dryer comprising a patch having a front portion, a middle portion, and a back portion, wherein the back portion has on it an adhesive for attaching the patch to an interior surface of a tumble dryer door, the middle portion contains a carrier that is impregnated with a fabric treatment composition, the front portion contains a flow control member or support member, and wherein the patch is attached to the interior surface of a tumble dryer door back wall whereby a portion of the fabric treatment composition is transferred onto fabrics in the tumble dryer as a result of contact between the patch and fabrics during a tumble drying cycle and wherein the fabric treatment composition is present in an amount to be used for multiple tumble drying cycles.

8. A device according to claim 7 wherein the fabric treatment composition is selected from the group consisting of perfumes, anti-static agents, dye transfer inhibitors, whitening agents, enzymes, stain repellents, insect repellents, sunscreens, malodour reduction or elimination agents, stain removers, and wrinkle reducing agents.

9. A device according to claim 7 wherein the device has an indicating means which indicates to the user when the device is either low or out of fabric treatment composition.

10. (Cancelled)

11. (Cancelled)

12. A method of treating fabrics in a tumble dryer during multiple tumble drying cycles comprising attaching a device according to claim 1 to the inside of a tumble dryer door and carrying out a tumble drying process with fabrics inside the tumble dryer.

13. A device according to claim 1 wherein the device is flexible.

14. A tumble dryer with a device according to claim 1.

15. A tumble dryer with a device according to claim 7.
